(19) United States
(12) Patent Application Publication
(10) Pub. No.: US 2024/0160927 A1
(43) Pub. Date: May 16, 2024

(54) SINGLE TRAINING SEQUENCE FOR NEURAL NETWORK USEABLE FOR MULTI-TASK SCENARIOS

(71) Applicant: NEC Laboratories America, Inc., Princeton, NJ (US)

(72) Inventors: Yumin Suh, Santa Clara, CA (US); Samuel Schulter, Long Island City, NY (US); Xiang Yu, Mountain View, CA (US); Abhishek Aich, Riverside, CA (US)

(21) Appl. No.: 18/503,313

(22) Filed: Nov. 7, 2023

Related U.S. Application Data
(60) Provisional application No. 63/423,089, filed on Nov. 7, 2022.
(60) Provisional application No. 63/450,685, filed on Mar. 8, 2023.
(60) Provisional application No. 63/463,369, filed on May 2, 2023.

(51) Int. Cl. G06N 3/08

(52) U.S. Cl. CPC G06N 3/08

(57) ABSTRACT

Systems and methods for performing multiple tasks with a single artificial intelligence model that can include training a supernet model for an application by splitting the application into tasks, and splitting the supernet model into subnets. The methods and systems can further assign the tasks computing budgets, and match the tasks to subnets by matching the computing budget of the tasks to the computing capacity of the subnets. Further, the methods and systems can perform the tasks with matching subnets to produce parameters that are used by the supernet to perform the application. The supernet combines all of the task to produce a model for the application and the supernet retains weights for the tasks to be used in subsequent applications.

### RELATED APPLICATION INFORMATION

This application claims priority to U.S. 63/463,369 filed on May 2, 2023, incorporated herein by reference in its entirety.

This application claims priority to U.S. 63/423,089 filed on Nov. 7, 2022, incorporated herein by reference in its entirety.

This application claims priority to U.S. 63/450,685 filed on Mar. 8, 2023, incorporated herein by reference in its entirety.

### BACKGROUND

### Technical Field

The present invention relates to machine learning. More particularly, the present invention relates to training of a neural network in a manner that allows for applicability to multiple tasks.

### Description of the Related Art

Many real-world applications need to solve several computer tasks, e.g., computer vision tasks, at the same time. For example, autonomous driving needs to recognize objects like lanes, traffic lights, and pedestrians, while measuring the speed and distance to the front car.

A unified system for multiple tasks can reduce the compute cost by sharing common computations over tasks. Each application can be constrained by multiple compute budgets depending on the conditions of the deployment environment. One needs to retrain the model to match each requirement. However, training and optimizing models separately for each scenario can require lots of effort and computing resources.

### SUMMARY

According to an aspect of the present invention, a computer implemented method is provided for training a neural network for multiple tasks without requiring retraining for the individual specifics of each task. More particularly, a computer implemented method for performing multiple tasks with a single artificial intelligence model is provided herein. In one embodiment, the method can include training a supernet model for an application by splitting the application into tasks, and splitting the supernet model into subnets; assigning the tasks computing budgets; matching the tasks to subnets by matching the computing budget of the tasks to the computing capacity of the subnets; performing the tasks with matching subnets to produce parameters that are used by the supernet to perform the application, wherein the supernet combines all of the task to produce a model for the application and the supernet retains weights for the tasks to be used in subsequent applications; and deploying the supernet using the model for the application.

In accordance with another embodiment of the present disclosure, a system or performing multiple tasks with a single artificial intelligence model is described. In one embodiment, the system includes a hardware processor; and a memory that stores a computer program product. The computer program product when executed by the hardware processor, causes the hardware processor to train a supernet model for an application by splitting the application into tasks, and splitting the supernet model into subnets. The system can then assigning the tasks computing budgets; and match, using the hardware processor, the tasks to subnets by matching the computing budget of the tasks to the computing capacity of the subnets. The system can further perform, using the hardware processor, the tasks with matching subnets to produce parameters that are used by the supernet to perform the application. The supernet combines all of the task to produce a model for the application and the supernet retains weights for the tasks to be used in subsequent applications. Finally, the supernet can deploy, using the hardware processor, the supernet using the model for the application.

In accordance with yet another embodiment of the present disclosure a computer program product for performing multiple tasks with a single artificial intelligence model. The computer program product can include a computer readable storage medium having computer readable program code embodied therewith. The program instructions executable by a processor to cause the processor to train a supernet model for an application by splitting the application into tasks, and splitting the supernet model into subnets. The computer program product can also assign the tasks computing budgets, and match the tasks to subnets by matching the computing budget of the tasks to the computing capacity of the subnets. The computer program product can also perform the tasks with matching subnets to produce parameters that are used by the supernet to perform the application, wherein the supernet combines all of the task to produce a model for the application and the supernet retains weights for the tasks to be used in subsequent applications. The computer program product can also deploy the supernet using the model for the application.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an illustration of a general environment depicting a single multi-tasking model that can be trained once and deployed to many different scenarios without retraining, in accordance with one embodiment of the present disclosure.

FIG. 2 is an illustration of training a supernet neural network by assigning task of the application to different sub-nets, in accordance with one embodiment of the present disclosure.

FIG. 3 is an illustration of an example environment illustrating a neural

network for an artificial intelligence model.

FIG. 4 is a block/flow diagram of an exemplary method for training a model with a multi-task architecture using a single training sequence, in accordance with embodiments of the present invention.

FIG. 5 is an illustrating of one embodiment of Configuration Invariant Knowledge Distillation (CI-KD) Loss, in accordance with one embodiment of the present disclosure.

FIG. 6 is a block/flow diagram of an exemplary method providing greater details into blocks 1-4 of the method described with reference to FIG. 4, in accordance with embodiments of the present invention.

FIG. 7 is a block/flow diagram of an exemplary processing system for training a model with a multi-task architecture using a single training sequence without requiring retraining in order to be applicable to the specifics of each task individually, in accordance with embodiments of the present invention.

### DETAILED DESCRIPTION OF PREFERRED EMBODIMENTS

In accordance with embodiments of the present invention, systems and methods are provided for a neural network that can be trained once for multi-task scenarios. The proposed concepts aim at a multi-task model that can be trained once and deployed without retraining for any scenario, where each scenario corresponds to a specific compute budget and the minimum required task accuracies. This will reduce training and deployment costs significantly.

For example, when deploying a surveillance system to multiple customers, the available compute budgets may vary from customer to customer. Models need to be retrained to optimize for different compute budgets. The computer implemented methods, systems and computer program products provide for training a model once and deploying it to multiple customers without re-training.

For example, when a surveillance system is deployed for multiple customers, the required recognition function may differ depending on the customer. For example, customer A needs to identify and track people, whereas customer B needs to track people only. But the model needs to be retrained to optimize for different task requirements. Our invention enables us to train the model once and deploy it to multiple customers without re-training.

Further, the above described surveillance system example is provided for illustrative purposes only. As will be described herein, the methods for training models are applicable to any application that employs artificial intelligence with neural networks, such as computer vision applications, traffic control applications, automated driving applications, as well as other applications.

In some examples, the computer implemented methods, systems and computer program products can allow for a single multi-tasking model that can be trained once and deployed to many different scenarios without retraining. Here, each scenario corresponds to user requirements specified by a computing budget and minimum task accuracies. In contrast to most existing methods which allow deploying one model for different compute budgets, the computer implemented methods, systems and computer program products can allow for deploying the model when both compute budgets and targeted task accuracies vary.

One aspect of the proposed invention is to train one multi-task model where its sub-networks are optimized for different scenarios, which corresponds to different compute budgets and target task accuracies. There are at least two key differences from the existing methods of training models. For one, is that the computer implemented methods, systems and computer program products allows the control on both task importance and compute budget. Prior to the present methods, other training methods only allowed control of the compute budget only.

In another aspect, the computer implemented methods, system and computer program products provide leaning models that can scale to a larger number of tasks, because it reuses the weights and sub architectures of one network, e.g., a single network. In contrast, other approaches not consistent with the present disclosure generate network weights using hypernetworks lacks scalability.

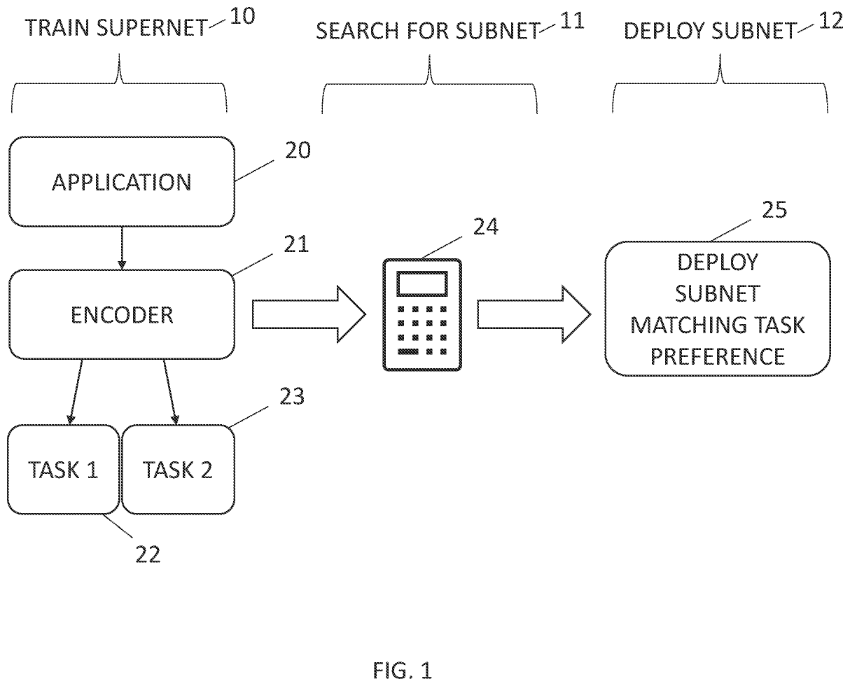

The computer implemented methods, systems and computer program products that can provide a model employing neural networks with a single training sequence that can be used for multi-task scenarios with retraining are now described with greater detail with reference to FIGS. 1-6.

FIG. 1 illustrates one embodiment of a general environment depicting a single multi-tasking model that can be trained once and deployed to many different scenarios without retraining, in accordance with one embodiment of the present disclosure. In some embodiments, a single network is provided that is capable solving multiple tasks. In some examples, a neural network is provided in which the memory footprint can be controlled. More specifically, to control the memory footprint, the depth is controlled of each stage. The stages can include to train the supernet 10, to search for a subnet 11 and to deploy the subnet 12. The depth refers to the number of layers in a neural network. Controlling the depth allows the data to pass through certain layers. More specifically, to control the memory footprint, the width of each layer may be controlled. The width of a layer refers to the number of neurons in a layer of the neural network. Controlling the width may be achieved by employing certain filters.

The methods, systems and computer program products of the present disclosure can address the problem of designing controllable multitask learning (MTL) architectures, which provides users with the ability to dynamically adjust the option of task performance preference given their compute budget. It has been determined, that one challenge is to devise multi-task learning (MTL) models that allow such dynamical adjustments over user's joint multi-task learning (MTL) constraints (relative importance of tasks and total compute cost) at test time without re-training. In some embodiments, to this end, Adjustable muLTitask ARchitectures or ALTAR models, are proposed that can dynamically adjust their runtime width non-uniformly across all layers based on joint constraints. ALTAR uses a fully-shared backbone among tasks to handle scalability, and doesn't require multiple external networks to control the multi-task learning (MTL) architecture to avoid compute overhead, and delivers high-quality sub-architectures designed on the basis of the user's constraints. To enable such effectual sub-architectures, we use a novel “configuration invariant knowledge distillation loss” that enforces sub-architectures to learn backbone representations that are invariant under different runtime width configurations. Further, a search algorithm is described herein that translates the user constraints to the runtime width configurations of both the shared encoder and task decoders for sampling the sub-architectures.

Referring to FIG. 1, in some embodiments, precise control on compute allocation as per their multi-task learning (MTL) performance preference, with the ability to change these preferences dynamically without re-training. To accomplish this, the methods, systems and computer program products provide a strategy where a multi task learning (MTL) SuperNet 50 is trained only once, but allows crafting SubNets 55, 60 that can be sampled based on the user's joint multi-task learning (MTL) constraints at test-time. The constraints may include compute cost and task preference. In the example, depicted in FIG. 1, an application e.g., computer vision, vehicle driving automation, traffic control, is performed by a trained model of a neural network, e.g., supernet 50. For example, the application 20 may range from large systems like autonomous cars analyzing traffic scenes to small closed-circuit television (CCTV) cameras for video surveillance with respective task performance preferences.

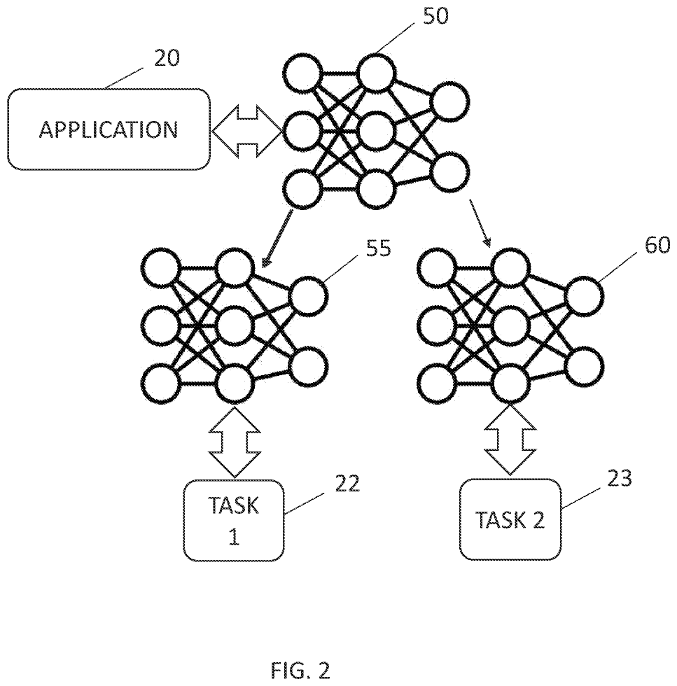

Training for the supernet 50 includes splitting tasks, e.g., Task 1 22 and Task 2 23, for the task to be trained by a subnet 55, 60, which transmits data back to the supernet 50. The tasks, e.g., Task 1 22 and Task 2 23, are sorted by high and low preference. “High” task preference for task i implies the SubNet's 55, 60 performance for task i is more important than other tasks. An encoder 21 can provide for communication between the supernet 50 and the subnets 55, 60. There is a single encoder 21 for each supernet, that communicates to the subnets 55, 60 for performance of the tasks 22, 23, as depicted in FIGS. 1 and 2.

In accordance with some embodiments of the present disclosure, the methods, systems and computer program products can take into account the computing budget, and then based on the computing budget for the separate tasks, e.g., Task 1 22 and Task 2 23, of the application 20 can search for a subnet 55, 60 for training. FIG. 1 illustrates computing a task budget, and task preference with reference number 24, and searching for a subnet with reference number 11. FIG. 1 further depicts deploying the subnet at block 12, which includes deploying the appropriate subnet by computing budget to the computing budget needed to perform the task at block 25.

FIG. 2 is an illustration of training a supernet neural network 50 by assigning task of the application to different sub-nets 55, 60. A supernet 50 is a neural network that represents the search space, including all possible architectures to be selected. It can be visualized as a Directed Acyclic Graph (DAG), where nodes are feature maps or module blocks and edges are operations (e.g., convolution, pooling, identity, zero). Subnets 55, 60 are derived from the supernet 50 and trained, with their parameters then combined back into the supernet 50. This process is repeated and each subsequent subnet inherits weights from the supernet 55, 60, which holds the parameters from previously trained subnets 55, 60, which is referred to as weight-sharing. This approach has made the network search process more efficient, reducing the time required from thousands of GPU days to just a few GPU days, e.g., less than 100 per day, compared to non-weight-sharing methods.

The computer implemented methods, systems and computer program products can provide controllable dynamic convolutional neural networks (CNN) for multi-task learning that can adjust for numerous joint user constraints. A user constraint may be to change task, e.g., task 1 and task 2, based upon memory constraints.

For example, as depicted in FIG. 1, a single multi-task learning (MTL) architecture can allow two users to use the same model but with custom task preferences based on the available compute cost. The user with higher compute requirement, e.g. automobiles (automated driving), may expect higher performance on task 1 22, but the user with lower compute, e.g., security systems, would prefer higher performance on task 2 23 given the budget.

It would be extremely inefficient to create and train multi-task learning (MTL) architectures for all such possible variations of user requirements due to expensive designing and deployment costs. This brings forth the necessary requirement of flexible multi-task learning (MTL) architectures that allow test-time trade-offs based on relative task importance and resource allocation.

It has been determined that one challenge is to train and design a controllable multi-task learning (MTL) model that leverages a shared backbone across different tasks, incorporates task decoders in resource allocation and task performance trade-off during test-time, while having ample dynamic range to satisfy user's diverse and changing multi-task learning (MTL) requirements.

To address the aforementioned challenges, the computer implemented methods, systems and computer program products create Adjustable muLTitask ARchitectures (ALTAR), which enables setting a number of filters (or width) in each layer of the architecture for testing under a wide range of joint multi-task preferences. As noted by setting the width in each layer, the number of neurons being used for training in a layer of the neural number is being set, i.e., selected. A “preference” is defined as a preferred task performance under available computation budget.

Instead of adjusting the branching points in the encoder streams or changing parameters through hyper-networks, the methods, systems and computer program products control the trade-off among tasks by the number of channels in each task decoder 25. Intuitively, a larger decoder 25 results in higher accuracy while using more computational resources. Provided herein is a convolutional neural network (CNN) based multi-task learning architectures. A convolutional neural network (CNN) is a type of artificial neural network used primarily for image recognition and processing, due to its ability to recognize patterns in images. A CNN is a powerful tool but requires millions of labelled data points for training. The CNN of the present disclosure shares the encoder 25 among all tasks, followed by individual task decoders and defines the search space by the parent network's non-uniform layer-wise runtime widths. The Encoder is typically a Recurrent Neural Network (RNN), but other types of networks such as Convolutional Neural Networks (CNNs) can also be used. The Decoder takes the context vector produced by the Encoder and uses it to generate the output data.

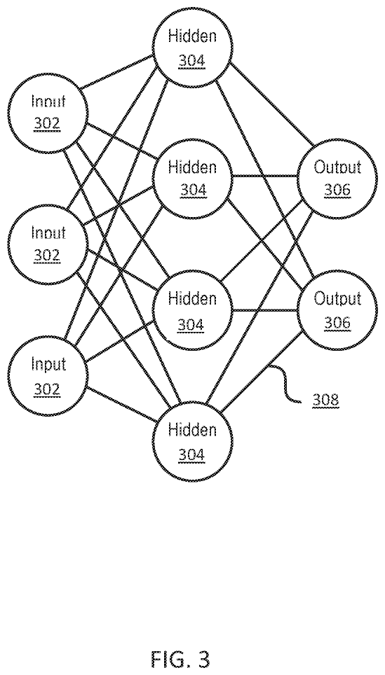

FIG. 3 is an illustration of an example environment illustrating a neural network for an artificial intelligence model. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 3, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted. In some embodiments, the streaming plan generator 303 trains to match search items extracted from definitions for requirements used in the requirement management tool to source code that is stored in repositories.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 308 may be implemented as resistive processing units (RPUs), generating a predictable current output when an input voltage is applied in accordance with a settable resistance.

An encoder-decoder architecture is a deep learning architecture. The encoder takes in an input sequence and produces a fixed-length vector representation of it, often referred to as a hidden or “latent representation”. This representation is designed to capture the important information of the input sequence in a condensed form. The decoder then takes the latent representation and generates an output sequence based on it. In some embodiments, an encoder—decoder architecture is a form of neural network architecture which are most suitable for the use cases where input is sequence of data and output is another sequence of data like machine translation use case. In other words, encoder-decoder architecture are most suitable for sequence-to-sequence modeling.

In this architecture, the input data is first fed through what's called as an encoder network. The encoder network maps the input data into a numerical representation that captures the important information from the input. The numerical representation of the input data is also called as hidden state. The numerical representation (hidden state) is then fed into what's called as the decoder network. The decoder network generates the output by generating one element of the output sequence at a time.

In accordance with some embodiments of the present disclosure, the runtime widths can be adjusted (or slimmed) independently. This can allow for sampling smaller multi task learning (MTL) architectures from the parent. The convolutional neural networks (CNN) include both the shared encoder and task decoders in the search space, and uses a novel strategy to convert the joint multi-task preferences to allowable filters in all layers of the architecture. This leads to efficient and high performing multi-task learning (MTL) sub-networks without the need of re-training.

Referring to FIG. 2, as the training is performed only once and the encoder is shared among tasks, the adjustable multi-task architecture, e.g., supernet 50, optimizes the sub-architectures, e.g., subnets 55, 60, by distilling the encoder knowledge of the parent architecture, e.g., the supernet 50 that is capable of handling task conflicts given its large capacity, to those of sub-architectures. In particular, it uses a novel ‘Configuration Invariant knowledge distillation’ (CI-KD) strategy to make the embeddings of the shared encoder invariant of the varying sub-architecture configuration. At test-time, the adjustable multi-task architecture uses the joint constraints and extracts a sub-architecture by searching for the most suitable encoder and decoder width configuration using a simple but novel evolution-based algorithm designed for multi-task learning models.

Interestingly, without any need for external hypernetworks (to predict large tensor weights of the parent architecture) and with a shared encoder 25 (that allows task scalability), the adjustable multi-task architecture demonstrates strong task preference—task accuracy—efficiency trade-offs.

The computer implemented methods, systems and computer program products can provide a method to sample high-performing multi-task learning (MTL) architectures from a single multi-task learning (MTL) SuperNet 50 that can satisfy multiple joint user constraints like user preference and storage.

We present a new strategy to train such a SuperNet MTL architecture that involves a shared backbone (allowing better scalability than prior works) and doesn't require hypernetworks to handle changes in MTL preferences (significantly reducing the compute overhead).

We demonstrate superior controllability on sampling child models, which includes sampling both backbone and the task decoders unlike prior works, while providing a larger range of “task preference—compute accuracy trade-off”.

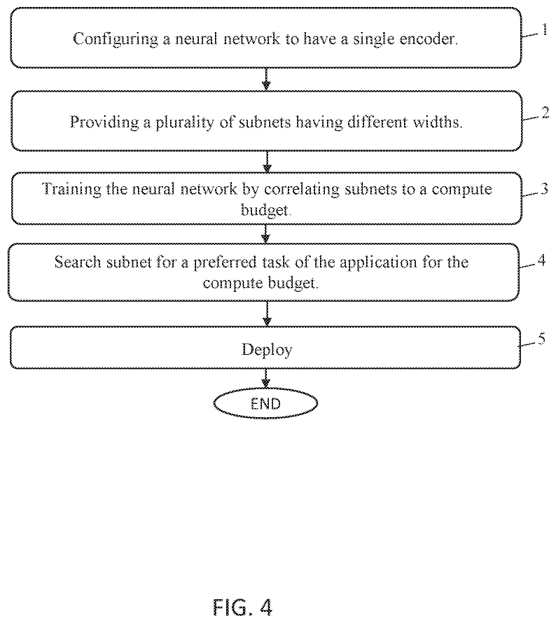

FIG. 4 illustrates a block diagram for one embodiment of a computer implemented method for training a model with a multi-task architecture using a single training sequence, in accordance with embodiments of the present invention. Block 1 includes configuring a network to have a single encode, and block 2 includes providing a plurality of subnets having different widths.

In one embodiment of a method for providing adjustable multi-ask architectures for joint user constraints, in which the following notations are employed. First, denote the N tasks from data distribution [symbol] (composed of training set [symbol] ₜᵣ, validation set [symbol] ᵥₐₗ, and testing set [symbol] ₜₑ) as { [symbol] , [symbol] , . . . , [symbol] }. Each task shares the input image x with corresponding outputs [symbol] ={y₁, y₂, . . . , y_{N}}. The image x is input data for a computer image application.

FIG. 4 illustrates one embodiment of a method for training a model with a multi-task architecture using a single training sequence. Block 1 of the method depicted in FIG. 4 may include configuring a neural network to have a single encoder.

A multi-task learning (MTL) parent architecture or SuperNet [symbol] is provided composed of a single shared encoder (across tasks) and N task decoders. [symbol] is end-to-end non-uniformly slimmable: every layer can be tuned to have it's own set of filters [symbol] (also called width) controlled by a width ratio ω∈(0,1] mutually exclusively. Let ω=[ωₘᵢₙ, . . . , ωₘₐₓ] be the set of possible values of width ratios with ωₘₐₓωₘᵢₙ representing the maximum and minimum possible values.

Block 2 of FIG. 4 may include providing a plurality of subnets 55, 60 having a different width. A sub-network (SubNet) [symbol] can be created from [symbol] by setting width ratios for all L layer denoted using a L-tuple [symbol] = [symbol] ω₁^{(ζ)}, ω₂^{(ζ)}, . . . , ω_{L}^{(ζ)} [symbol] ∈ω×ω× . . . ω. The smallest may be referred to as SubNet [symbol] , setting all the layers in [symbol] to smallest width ratio allowed in ω. The set of loss functions for the N tasks be { [symbol] ₁, [symbol] ₂, . . . , [symbol] _{N}}. The task preference list is denoted as T=[τ₁, τ₂, . . . , τ_{N}] with τᵢ∈[0.0, 1.0] (higher value indicates higher task preference in available compute budget). Finally, the weights of [symbol] are denoted as θ.

Block 3 of the computer implemented method that is depicted in FIG. 3 may include training the convoluted neural network to correlate the subnets, e.g., by width, to the compute budget. In some embodiment, the multi task learning (MTL) SuperNet [symbol] is trained to allow for crafting multiple multi task learning (MTL) SubNets [symbol] operable for a wide range of joint multi task learning (MTL) user budgets (compute budget Fᵤₛₑᵣ, and task preference τᵤₛₑᵣ) with minimal performance drop.

The SuperNet [symbol] (and the SubNets [symbol] ) takes image x as input and predicts N task outputs [symbol] . To train [symbol] , we define the following problem:

$${arg min}_{θ} {𝔼}_{x , 𝒴 \sim {𝒟}_{tr}} {\sum }_{n = 1}^{N} {ρ}_{n} {ℒ}_{n} ( θ ) \qquad Equation ( 1 )$$

Here, ρₙ is the weight of n^{th} task loss. Once [symbol] is trained, the joint constrained search for obtaining [symbol] can be expressed as the following problem:

$$\begin{matrix}{min}_{𝒮 ( ζ )} {𝔼}_{x , 𝒴 \sim {𝒟}_{val}} {\sum }_{n = 1}^{N} {ρ}_{n} {ℒ}_{n} ( {𝒮}^{( ζ )} ) \\ s . t . compute ( {𝒮}^{( ζ )} ) \leq {F}_{user} \\ task preference ( {𝒮}^{( ζ )} ) = {τ}_{user}\end{matrix} , \qquad Equation ( 2 )$$

During training, Equation 1 is solved by constructing a SuperNet [symbol] parameterized by layer-wise width ratios in ω. During inference, Equation 2 can be solved by searching for the most suitable encoder and decoder width configuration using an evolution based search algorithm based on the joint constraints. The training is performed only once, whereas the search is performed for each deployment scenario.

Training the multitask learning (MTL) supernet can include a Supernet training strategy where the MTL SuperNet 50 is trained collaboratively with the MTL SubNets. The collaborative training of the SuperNet 50 and the subnets 55, 60 includes a knowledge distillation loss to transfer the knowledge of the largest capacity encoder, which has less task conflicts, to smaller capacity encoders of the SubNets.

In some embodiments, a Sandwich Rule (SR) training is applied for single task learning (STL) requires that in each training iteration, the SuperNet 50 is updated with the collectively accumulated loss gradients of the model at largest width, smallest width and b randomly chosen (non-uniform) widths.

Further, the STL SubNets in the sandwhich rule SR are optimized only using the predictions of the largest width model (i.e. SuperNet). In some embodiments, each SubNet is enforced to learn the multi task learning (MTL) data distribution [symbol] directly from the available ground-truth labels y.

The training loss of collective learning, i.e., training each SubNet as the SuperNet from ground-truth labels) is denoted as [symbol] _{co}. Training SubNets with ground-truth labels can avoid the need to train the multi-task learning (MTL) SubNets from the output predictions of a weak parent MTL model (as it is being trained from scratch).

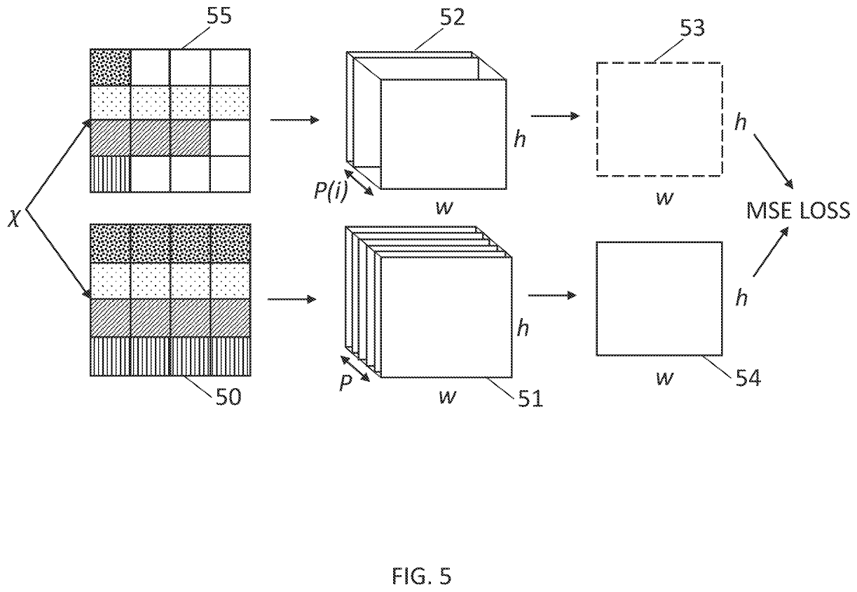

In some embodiments, a methodology is providing for distilling the knowledge of the parent model [symbol] to SubNets without using output predictions, hence providing encoder-based knowledge distillation (KD) loss, i.e., Configuration Invariant KD (CI-KD) Loss, as depicted in FIG. 5. The CI-KD loss is an in-place distillation loss [symbol] _{kd}, which transfers the encoder knowledge of the Supernet [symbol] to the encoders of sub-networks [symbol] . The encoder of the Supernet [symbol] is capable of handling multi-task conflicts due to it's high capacity. In some embodiments, the methods, systems and computer program products describe herein aim to teach the encoders of the smaller models from its features.

In some embodiments, minimizing distance is proposed between the encoder features computed from parent model [symbol] and all the child models (i.e. [symbol] , [symbol] , and [symbol] , where [symbol] and [symbol] are random SubNets) involved in the sandwich setup. Now, this loss cannot be directly estimated: the features of [symbol] 's encoder (denoted by z∈ [symbol] with number of channels as p, height as h and w), and other child models (denoted by z⁽ⁱ⁾∈ [symbol] with number of channels as p⁽ⁱ⁾) are of different sizes due to the different configurations of the SubNet encoders, i.e. p>p⁽ⁱ⁾. To make the shared encoder features configuration invariant, the methods described herein compute the average features along the channel dimensions for all models in the Sandwich. Further, the methods, systems and computer program products can then minimize the mean square error loss between theses channel-averaged features of the parent model and the b−1 child models as follows.

$${ℒ}_{k d} = \frac{1}{b - 1} {\sum }_{i}^{b} M S E ( \hat{z} , {\hat{z}}^{( i )} ) , \hat{z} = \frac{1}{p} {\sum }^{p} z \qquad Equation ( 3 )$$

FIG. 5 illustrates one Configuration Invariant Knowledge Distillation (CI-KD) Loss. This loss encourages the shared encoder features to be invariant of the i\hat{ }“th” SubNet capacity, by enforcing them to be close to the SuperNet's shared encoder features. The supernet is identified by 50 and the subnet is identified by 55. The encoder features consider both the width (w,h) of the layer and the depth (p). As illustrated the encoder features 51 for the supernet 50 has a greater number of layers, and generally a greater width for the layers than the encoder features 52 for the subnet 55. The channel-dim average for the subnet 55 is illustrated by reference number 53. The channel-dim average for the supernet 50 is illustrated by reference number 54.

The distillation loss is illustrated in FIG. 5. To summarize, the SuperNet learning loss only includes Eq. 1, whereas the i^{th} SubNet learning loss includes both with Eq. 1 and λ [symbol] _{kd} (λ is the weight of the CI-KD loss). This loss encourages the shared encoder features to be invariable of the i^{th} supernet capacity, e.g., by forcing them to be close to the supernet's shared encoder features.

Referring to FIG. 3, the method may continue to searching for a subnet for a preferred task of the application at the compute budget at block 4. Searching for subnets 55, 60 may include both the encoder and decoders being searched. The strategy to search SubNets 55, 60 is based on the user's joint constraint, e.g., task and available compute budget.

Searching based on joint user preference to sample subnetworks that follow the user's joint constraints of task preference and compute budget can include divide the sampling into two parts. For example, step 1 can include to sample the task decoders as they are independent for each task based on user's task preference, and step 2 can include to sample the shared encoder that satisfies the overall compute budget (along with the sampled decoders).

In one embodiment, step 1 may include sampling the task decoders. In some embodiments, sampling the task decoders includes to set the width ratios of the task decoders based on the task preference. For example, the computer implemented methods can map each τᵢ to the discrete uniform range of ω˜ [symbol] (ωₘᵢₙ, ωₘₐₓ). Assuming τ˜ [symbol] (0,1) as a uniform distribution with unit density when 0≤τ≤1 (0 otherwise), τᵢ is mapped to a decoder width ratio ωᵢ as:

ωᵢ=ωₘᵢₙ+(ωₘₐₓ−ωₘᵢₙ)τᵢ Equation (4)

Clearly, ωᵢ∝τᵢ i.e. the decoder of the task with higher preference will be assigned a higher width ratio. This can allow for a larger computational budget in the available user's budget to the higher preferred task. Once all the decoders are fixed using Equation 4, search is performed for the width ratios for the shared encoder which we discuss next.

In one embodiment, step 2 can include sampling the shared encoder. The aim is to sample a width ratio list for the shared encoder, that supports the best performance out of the sampled decoders. To accomplish this, the methods, systems and computer program products use an evolution-based search algorithm.

For example, the search algorithm can include three components. First, we initialize a pool [symbol] of P models ( [symbol] ={ [symbol] , [symbol] , . . . , [symbol] }), all with the fixed decoder configuration obtained from Step 1. Each of these models are characterized by the same width ratio across all encoder layers. Next, we evolve [symbol] in order to find a better performing model than the initialized ones by leveraging the flexibility of choosing width ratios for each layer mutually exclusively in [symbol] . We randomly choose K<L layers of the encoder and change the width ratio ωₖ by the rule:

\hat{ω}ₖ=ωₖ−η sign(F^{(ζ)}−Fₜₒₜₐₗ) Equation (5)

Here, F^{(ζ)} is the computational cost of [symbol] (e.g. GMACs), and Fₜₒₜₐₗ is the computational budget set by the user. Further, set η=0.1 for a design specification ωᵢ−ωⱼ=0.1. This evolution step creates a new model [symbol] which is added back to [symbol] .

In the end, the best performing model from is provided for deployment. At all steps, we ensure that each model [symbol] satisfies the user's compute budget constraint. In order to quickly evaluate the quality of models in [symbol] , we build a subsidiary neural network [symbol] that provides a feedback on [symbol] , s approximate performance. [symbol] eliminates the need for repeated cost of getting the measured accuracy by providing a predicted accuracy. Specifically, [symbol] is optimized to take [symbol] 's width configuration as input and predict the approximate performance of this configuration [5]. To train [symbol] , we first create K examples of [ [symbol] , ( [symbol] ₁, . . . , [symbol] _{N})] pairs by randomly sampling M SubNets with different configurations [symbol] , and computing their task losses on [symbol] ᵥₐₗ. [symbol] contains the list of width ratios computed for the shared encoder and the task decoders. In our experiments, we choose M=2000.

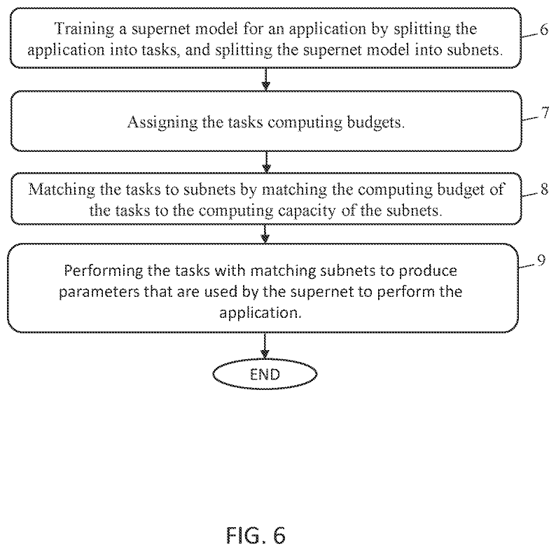

In some embodiments, blocks 1-4 of FIG. 4 may be performed using the sequence depicted in FIG. 6. Block 6 includes training a supernet model for an application by splitting the application into tasks, and splitting the supernet model into subnets. Block 7 includes assigning the tasks computing budgets. Block 8 includes matching the tasks to subnets by matching the computing budget of the tasks to the computing capacity of the subnets. Block 9 includes performing the tasks with matching subnets to produce parameters that are used by the supernet to perform the application, wherein the supernet combines all of the task to produce a model for the application and the supernet retains weights for the tasks to be used in subsequent applications.

Referring to back to FIG. 4, the computer implemented method may end with deploying the supernet at block 5. Block 5 can include deploying the supernet using the model for the application.

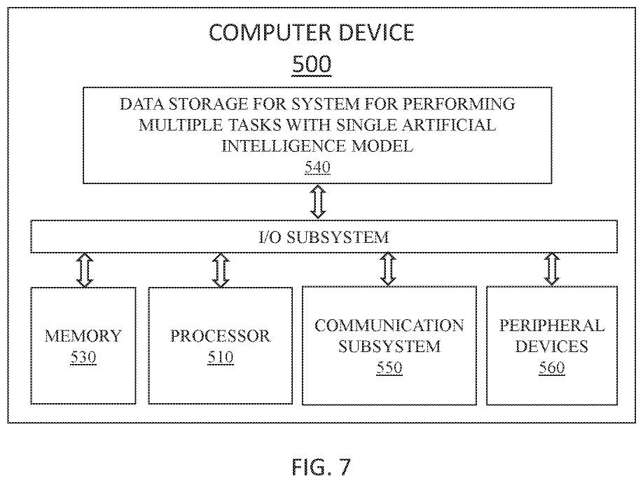

Referring now to FIG. 7, an exemplary computing device 500 is shown, in accordance with an embodiment of the present invention. The computing device 500 can be configured to perform multiple tasks with a single artificial intelligence model. For example, the system may include a hardware processor 510; and a memory 530 that stores a computer program product. The memory 530 may include data storage 540.

The contents of the data storage 540 when executed by the hardware processor 510, causes the hardware processor 510 to train a supernet model for an application by splitting the application into tasks, and splitting the supernet model into subnets. The data storage 540 of the system 500 may also employ the hardware processor 510 to assign the tasks computing budgets; and match the tasks to subnets by matching the computing budget of the tasks to the computing capacity of the subnets. The data storage 540 of the system 500 may also employ the hardware processor 510 to perform the tasks with matching subnets to produce parameters that are used by the supernet to perform the application. The supernet combines all of the task to produce a model for the application and the supernet retains weights for the tasks to be used in subsequent applications. Further, the data storage 540 of the system 500 may also employ the hardware processor 510 to deploy, using the hardware processor, the supernet using the model for the application.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 7, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code for the entity extractor 541, the knowledge graph expansion generator 542, and the knowledge predictor 543.

Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. For example, a computer program product may be provided for performing multiple tasks with a single artificial intelligence model. The computer program product may a computer readable storage medium having computer readable program code embodied therewith, the program instructions executable by a processor to cause the processor to train a supernet model for an application by splitting the application into tasks, and splitting the supernet model into subnets; assign the tasks computing budgets; and match the tasks to subnets by matching the computing budget of the tasks to the computing capacity of the subnets. The computer program product can also perform the tasks with matching subnets to produce parameters that are used by the supernet to perform the application, wherein the supernet combines all of the task to produce a model for the application and the supernet retains weights for the tasks to be used in subsequent applications; and deploy the supernet using the model for the application.

A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method for performing multiple tasks with a single artificial intelligence model comprising:
training a supernet model for an application by splitting the application into tasks, and splitting the supernet model into subnets;
assigning computing budgets to the tasks;
matching the tasks to subnets by matching the computing budget of the tasks to computing capacity of the subnets;
performing the tasks with matching subnets to produce parameters that are used by the supernet to perform the application, wherein the supernet combines all of the task to produce a model for the application and the supernet retains weights for the tasks to be used in subsequent applications; and
deploying the supernet using the model for the application.

2. The computer implemented method of claim 1, wherein a single encoder is used to communicate between the supernets and the subnets.

3. The computer implemented method of claim 2, wherein the tasks are ranked by the single encoder by preference.

4. The computer implemented method of claim 3, wherein preference is ranked by importance of performing a task for the application to perform, and compute budget for performing the task.

5. The computer implemented method of claim 1, wherein the matching tasks to subnets by matching the computing budget comprises matching at least one of a depth of the subnet to the computing budget and a width of the subnet to the computing budget.

6. The computer implemented method of claim 5, wherein the depth is penetration into a number of layers for performing a task and the width is a number of neurons in a layer of the subnet.

7. The computer implemented method of claim 1, wherein the supernet retaining the weights for the tasks to be used in the subsequent applications performed by the single artificial intelligence model is weight sharing that can reduce computing budget from thousands of GPUs a day for a non-weight shared application to less than 100 GPUs a day for a weight sharing application.

8. A system for performing multiple tasks with a single artificial intelligence model comprising:
a hardware processor; and
a memory that stores a computer program product, the computer program product when executed by the hardware processor, causes the hardware processor to:
train, using the hardware processor, a supernet model for an application by splitting the application into tasks, and splitting the supernet model into subnets;
assign, using the hardware processor, computing budgets to the tasks;
match, using the hardware processor, the tasks to subnets by matching the computing budget of the tasks to a computing capacity of the subnets;
perform, using the hardware processor, the tasks with matching subnets to produce parameters that are used by the supernet to perform the application, wherein the supernet combines all of the task to produce a model for the application and the supernet retains weights for the tasks to be used in subsequent applications; and
deploy, using the hardware processor, the supernet using the model for the application.

9. The system of claim 8, wherein a single encoder is used to communicate between the supernets and the subnets.

10. The system of claim 9, wherein the tasks are ranked by the single encoder by preference.

11. The system of claim 10, wherein preference is ranked by importance of performing a task for the application to perform, and compute budget for performing the task.

12. The system of claim 8, wherein the match tasks to subnets by matching the computing budget comprises matching at least one of a depth of the subnet to the computing budget and a width of the subnet to the computing budget.

13. The system of claim 12, wherein the depth is penetration into the number of layers for performing a task and the width is a number of neurons in a layer of the subnet.

14. The system of claim 8, wherein the supernet retaining the weights for the tasks to be used in the subsequent applications performed by the single artificial intelligence model is weight sharing that can reduce computing budget from thousands of GPUs a day for a non-weight shared application to less than 100 GPUs a day for a weight sharing application.

15. A computer program product for performing multiple tasks with a single artificial intelligence model, the computer program product can include a computer readable storage medium having computer readable program code embodied therewith, the program instructions executable by a processor to cause the processor to:
train a supernet model for an application by splitting the application into tasks, and splitting the supernet model into subnets;
assign computing budgets to the tasks;
match the tasks to subnets by matching the computing budget of the tasks to a computing capacity of the subnets;
perform the tasks with matching subnets to produce parameters that are used by the supernet to perform the application, wherein the supernet combines all of the task to produce a model for the application and the supernet retains weights for the tasks to be used in subsequent applications; and
deploy the supernet using the model for the application.

16. The computer program product of claim 15, wherein a single encoder is used to communicate between the supernets and the subnets.

17. The computer program product of claim 16, wherein the tasks are ranked by the single encoder by preference.

18. The computer program product of claim 17, wherein preference is ranked by importance of performing a task for the application to perform, and compute budget for performing the task.

19. The computer program product of claim 15, wherein the match tasks to subnets by matching the computing budget comprises matching at least one of a depth of the subnet to the computing budget and a width of the subnet to the computing budget.

20. The computer program product of claim 19, wherein the depth is penetration into a number of layers for performing a task and the width is a number of neurons in a layer of the subnet.
